(19) United States
(12) Patent Application Publication
(10) Pub. No.: US 2009/0085841 A1
(43) Pub. Date: Apr. 2, 2009

(54) Plasma display, controller therefor and driving method thereof

(76) Inventors: Jung-Jin Choi, Suwon-si (KR); Jang-Ho Moon, Suwon-si (KR); Youn-Kyoung Kim, Suwon-si (KR); Hyun Kang, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/286,289

(22) Filed: Sep. 30, 2008

(30) Foreign Application Priority Data
Oct. 1, 2007 (KR) 10-2007-0098752

(51) Int. Cl. G09G 3/28

(52) U.S. Cl. 345/68; 345/60

(57) ABSTRACT

A plasma display, a controller therefor and a method of driving determines a total number of sustain pulses according to a screen load ratio, and allocates sustain pulses to each subfield according to a weight value of that subfield. A ratio of overlap sustain pulses to non-overlap sustain pulses is determined according to the weight value of each subfield, and the overlap and non-overlap sustain pulses are arranged according to the determined ratio. The arranged sustain pulses are applied to a plurality of first and second electrodes that perform a display operation during a sustain period.

### BACKGROUND OF THE INVENTION

1. Field of the Invention

Embodiments relate to a plasma display, a controller therefore, and a driving method thereof.

2. Description of the Related Art

A plasma display panel (PDP) is a flat panel display that uses plasma generated by gas discharge to display characters or images. The PDP includes a plurality of discharge electrode pairs and a plurality of address electrodes crossing the plurality of discharge electrode pairs.

One frame of the plasma display is divided into a plurality of subfields to drive the plasma display. Turn-on/turn-off cells (i.e., cells to be turned on or off) are selected during an address period of each subfield. A sustain discharge occurs for a number of times corresponding to a luminance weight of a corresponding subfield in the light emitting cells during a sustain period of each subfield. During the sustain period, sustain pulses, alternately having a high level voltage and a low level voltage and having opposite phases, are applied to the discharge electrode pairs. When the high level voltage of the sustain pulse is changed to the low level voltage, a self-erase discharge is generated between an address electrodes and one of the discharge electrodes of a corresponding discharge electrode pair before the sustain discharge is generated between the two electrodes. As a result, some wall charges may be erased. Accordingly, a subsequent sustain discharge may not be appropriately generated and the amount of wall charges may vary in the turn-on cells and the turn-off cells. Therefore, an after-image effect or discharge spots may occur.

The above information disclosed in this Background section is only for enhancement of understanding of the background of the invention and therefore it may contain information that does not form prior art that is already known in this country to a person of ordinary skill in the art.

### SUMMARY OF THE INVENTION

Embodiments of the present invention are therefore directed to a plasma display, a controller therefor, and a driving method thereof, which substantially overcome one or more of the problems due to the limitations and disadvantages of the related art

An embodiment of the present invention may provide a plasma display, a controller therefor, and driving method that may prevent an after-image effect.

Another embodiment of the present invention may provide a plasma display, a controller therefor, and driving method that may prevent discharge spots.

Still another embodiment of the present invention may provide a plasma display, a controller therefor, and driving method that may appropriately generate a sustain discharge.

At least one of the above and other advantages may be realized by providing a method for driving a plasma display while driving one frame in a plurality of subfields respectively having weight values in a plasma display including a plurality of discharge cells, a total number of sustain pulses applied to the discharge cells during the frame is determined from a plurality of video signals input during one frame, the sustain pulses are allocated to each subfield based on the total number of sustain pulses, a ratio of overlap sustain pulses to non-overlap sustain pulses of each subfield is determined according to a weight value of each subfield, and the sustain pulses allocated to each subfield are arranged in each subfield according to the determined ratio.

At least one of the above and other advantages may be realized by providing a plasma display including a plurality of discharge cells, a controller, and a driver. The controller is configured to divide one frame into a plurality of subfields, allocate sustain pulses to each subfield, determine a ratio of overlap sustain pulses and non-overlap sustain pulse in each subfields according to the weight value of each subfield, and arranges the sustain pulses allocated to the respective subfields as the overlap sustain pulses and the non-overlap sustain pulses based on the determined ratio. The driver sequentially applies the arranged sustain pulses to the plurality of discharge cells in the respective subfields.

At least one of the above and other advantages may be realized by providing a method for driving a plasma display while dividing one frame in a plurality of subfields in the plasma display including a first electrode and a second electrode performing a display operation together, a plurality of first sustain pulses are applied to the first electrode in a sustain period of each subfields, and a plurality of second sustain pulses are applied to the second electrode while having an opposite phase to that of the first sustain pulse in the sustain period. When the plurality of first and second sustain pulses are grouped into a plurality of groups according to pulse type, the first and second sustain pulses of a first group, which includes the first sustain pulse that is firstly applied to the plurality of first electrodes in the sustain period, partially overlap, and the first and second sustain pulses of a second group among the plurality of groups do not overlap. In addition, the number of first and second sustain pulses included in the first group varies according to a weight value of each of the subfields.

At least one of the above and other advantages may be realized by providing an exemplary controller for use with a plasma display device, the controller including a dividing unit configured to divide one frame into a plurality of subfields, a ratio unit configured to determine a ratio of overlap sustain pulses and non-overlap sustain pulses in the respective subfields according to a weight value of the respective subfields, and an arranging unit configured to arrange the sustain pulses allocated to the respective subfields as the overlap sustain pulses and the non-overlap sustain pulses based on the determined ratio.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a plasma display according to an exemplary embodiment of the present invention;

FIG. 2 illustrates sustain pulses that all overlap

FIG. 3 illustrates a controller according to an exemplary embodiment of the present invention;

FIG. 4 illustrates a flowchart of operation of the controller according to an exemplary embodiment of the present invention; and

FIG. 5A and FIG. 5B illustrate sustain pulses according to an exemplary embodiment of the present invention.

### DETAILED DESCRIPTION OF THE INVENTION

Korean Patent Application No. 10-2007-0098752, filed on October 1, 2007, in the Korean Intellectual Property Office and entitled: “Plasma Display and Driving Method Thereof,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art. Like reference numerals designate like elements throughout the specification.

When it is described in the specification that a voltage is maintained, it should not be understood to strictly imply that the voltage is maintained exactly at a predetermined voltage. To the contrary, even if a voltage difference between two points varies, the voltage difference is expressed to be maintained at a predetermined voltage in the case in which the variance is within a range allowed in design constraints or in the case in which the variance is caused due to a parasitic component that is usually disregarded by a person of ordinary skill in the art.

A plasma display according to an exemplary embodiment of the present invention and a driving method thereof will now be described.

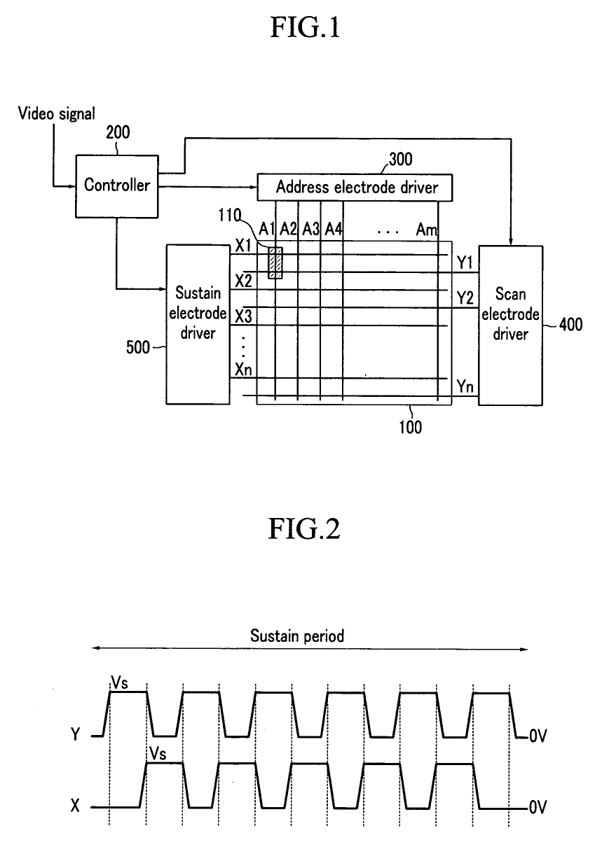

FIG. 1 illustrates the plasma display according to an exemplary embodiment of the present invention. FIG. 2 illustrates a sustain pulse according to an exemplary embodiment of the present invention.

As shown in FIG. 1, the plasma display according to the exemplary embodiment of the present invention may include a plasma display panel (PDP) 100, a controller 200, an address electrode driver 300, a scan electrode driver 400, and a sustain electrode driver 500.

The PDP 100 may include a plurality of address electrodes A1 to Am extending in a column direction, and a plurality of sustain and scan electrodes X1 to Xn and Y1 to Yn extending in a row direction in pairs. In general, the sustain electrodes X1 to Xn are respectively formed to correspond to the scan electrodes Y1 to Yn. The sustain electrodes and scan electrodes may perform a display operation for displaying an image in a sustain period.

The scan electrodes Y1 to Yn and the sustain electrodes X1 to Xn may cross the address electrodes A1 to Am. Discharge spaces at crossing regions of the address electrodes A1 to Am and the sustain and scan electrodes X1 to Xn and Y1 to Yn form discharge cells 110

It is to be noted that the above construction of the PDP is only an example, and panels having different structures, to which a driving waveform to be described later can be applied, may be applied to the present invention.

The controller 200 may receive an external video signal, and may output an address electrode driving control signal, a sustain electrode driving control signal, and a scan electrode driving control signal. The address electrode driver 300 may apply a driving voltage to the plurality of A electrodes A1 to Am according to the driving control signal from the controller 200. The scan electrode driver 400 may apply a driving voltage to the plurality of Y electrodes Y1 to Yn according to the driving control signal from the controller 200. The sustain electrode driver 500 may apply a driving voltage to the plurality of X electrodes X1 to Xn according to the driving control signal from the controller 200.

In further detail, the address, scan, and sustain electrode drivers 300, 400, and 500 may select light emitting cells and non-light emitting cells in a corresponding subfield from among the plurality of discharge cells 110 during the address period of each subfield. During the sustain period of each subfield, as shown in FIG. 2, the scan electrode driver 400 may apply a sustain pulse alternately having a high level voltage Vs and a low level voltage 0V to the plurality of Y electrodes Y1 to Yn a number of times corresponding to a weight value of the corresponding subfield. In addition, the sustain electrode driver 500 may apply a sustain pulse having an opposite phase to that of the Y electrodes Y1 to Yn to the plurality of X electrodes X1 to Xn. Thereby, a difference between each Y electrode and each X electrode alternately becomes a Vs voltage and a −Vs voltage. Therefore a sustain discharge is repeatedly generated in a turn-on discharge cell a predetermined number of times.

As may be seen in FIG. 2, when the sustain pulse applied to the Y electrode during the sustain period partially overlaps the sustain pulse applied to the X electrode immediately after the sustain pulse applied to the Y electrode during the sustain period. That is, while the Vs voltage is applied to the X electrode, a voltage at the Y electrode decreases from the Vs voltage to the 0V voltage for a predetermined time after the Vs voltage is applied to the X electrode. In a like manner, while the Vs voltage is applied to the Y electrode, a voltage at the X electrode decreases from the Vs voltage to the 0V voltage for a predetermined time after the Vs voltage is applied to the Y electrode. Accordingly, since the A electrode becomes a cathode with respect to the Y electrode (or the X electrode), a discharge between the Y and X electrodes may be generated earlier than a self-erase discharge between the Y electrode (or the X electrode) and the A electrode.

Discharge in a cell is determined by the amount of secondary electrons emitted from the cathode when positive ions collide against the cathode, which is referred to as a γ process. In the PDP, phosphor may cover the A electrodes to express colors, and a protective layer, e.g., a layer made of materials having a high secondary electron emission coefficient such as an MgO, may cover the X and Y electrodes to increase sustain discharge efficiency. Accordingly, since the A electrode covered with the phosphor functions as the cathode when a voltage between the A and Y electrodes exceeds a discharge firing voltage, the discharge between the A electrode and the Y electrode (or the X electrode) is delayed. Thereby, the self-erase discharge may be generated between the A electrode and the Y electrode (or the X electrode) while the voltage at the Y electrode (or the X electrode) decreases from the Vs voltage to the 0V voltage, and the sustain discharge is generated between the X and Y electrodes before the wall charges are eliminated. Accordingly, an after-image effect or discharge spots may be prevented, and a subsequent sustain discharge may be stably generated.

However, when the sustain pulse shown in FIG. 2 is applied during the sustain period, damage to the protective layer covering the Y and X electrodes may be increased. Accordingly, a life-span of the PDP may be reduced, and a luminance maintenance rate may be considerably deteriorated.

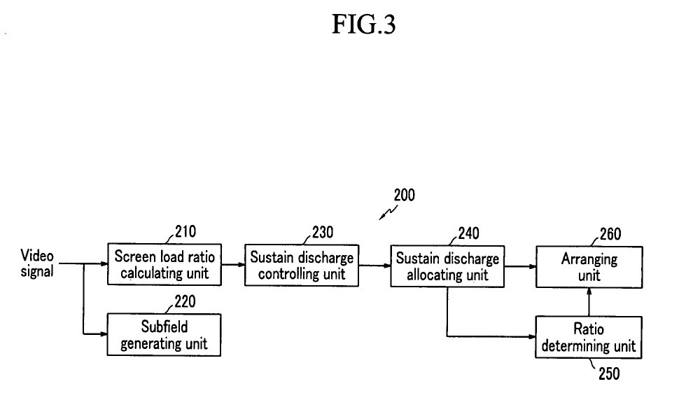

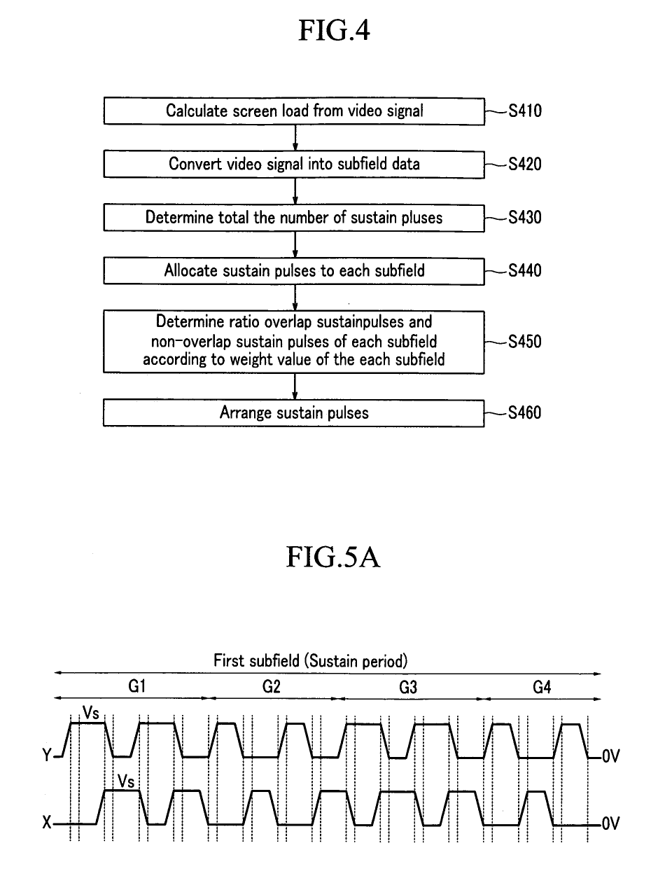

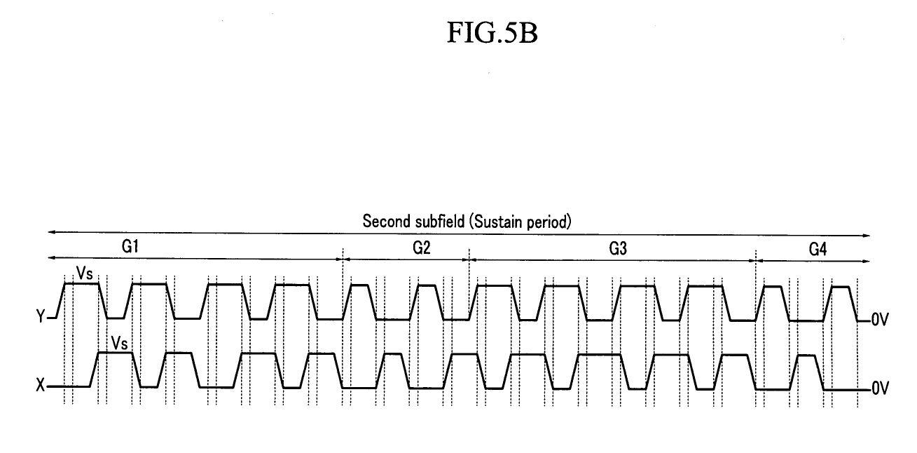

An exemplary embodiment of the present invention for preventing the deterioration of the luminance maintenance rate and the self-erase discharge will be described with reference to FIG. 3, FIG. 4, FIG. 5A, and FIG. 5B. Hereinafter, the sustain pulse will be referred to as an “overlap sustain pulse” when the sustain pulse applied to the Y electrode overlaps the sustain pulse applied to the X electrode, i.e., when both the Y electrode and the X electrode are at the high voltage, e.g., the Vs voltage, simultaneously. The sustain pulse will be referred to as a “non-overlap sustain pulse” when the sustain pulse applied to the Y electrode does not overlap the sustain pulse applied to the X electrode, i.e., when the Y electrode and the X electrode are never at the high voltage simultaneously, although they may be at the low voltage, e.g., 0V, simultaneously.

FIG. 3 illustrates a block diagram of a controller 200 according to an exemplary embodiment of the present invention. FIG. 4 illustrates a flowchart of an operation of the controller 200 according to an exemplary embodiment of the present invention. In addition, FIG. 5A and FIG. 5B illustrate sustain pulses according to an exemplary embodiment of the present invention.

As shown in FIG. 3, the controller 200 according to an exemplary embodiment of the present invention may include a screen load ratio calculating unit 210, a subfield generating unit 220, a sustain discharge controlling unit 230, a sustain discharge allocating unit 240, a ratio determining unit 250, and an arranging unit 260.

The screen load ratio calculating unit 210 may calculate a screen load ratio from the plurality of video signals input for one frame in operation S410. For example, the screen load ratio calculating unit 210 may calculate the screen load ratio from an average signal level (ASL) of the video signals of one frame as given in Equation 1. Here, the plurality of video signals respectively correspond to the plurality of discharge cells 110 illustrated in FIG. 1.

$$ASL ( {\sum }_{V} {R}_{n} + {\sum }_{V} {G}_{n} + {\sum }_{V} {B}_{n} ) / 3 N \qquad [ Equation 1 ]$$

In Equation 1, Rₙ, Gₙ, and Bₙ respectively denote gray levels of R, G, and B image data, V denotes one frame, and 3N denotes the number of R, G, and B image data input for one frame.

The subfield generating unit 220 may convert the plurality of video signals into a plurality of subfield data in operation S420.

The sustain discharge controlling unit 230 may determine a total number of sustain pulses allocated to one frame, according to the screen load ratio in operation S430. In this case, the sustain discharge controlling unit 230 may store the total number of sustain pulses determined according to the screen load ratio in a look-up table, or may calculate the total number of sustain pulses by performing a logic operation on the data corresponding to the screen load ratio. Thus, when the number of light emitting cells is increased, thus increasing the screen load ratio, the total number of sustain pulses may be decreased to prevent an increase of power consumption.

The sustain discharge allocating unit 240 may respectively allocate the sustain pulses in proportion to the luminance weight values in operation S440.

The ratio determining unit 250 may determine a ratio of the overlap sustain pulses and the non-overlap sustain pulses according to the weight value of each subfield in operation S450. The ratio of the overlap sustain pulses to the non-overlap sustain pulses may be stored in a look-up table.

According to an exemplary embodiment of the present invention, the ratio determining unit 250 may increase a ratio of the overlap sustain pulses to the non-overlap sustain pulses as the weight value of subfields increases. In general, since the number of sustain pulses in a subfield having a low weight value is less than the number of sustain pulses in a subfield having a high weight value, the subfield having the lower weight value is less influenced by a period required for the sustain pulses to reach a discharge cell than the subfield having the higher weight value.

Accordingly, the ratio determining unit 250 may set the ratio of the overlap sustain pulses to be 0, i.e., no overlap sustain pulses are used, in the subfield having the lowest weight value from among a plurality of the subfields, and may gradually increase the ratio of the overlap sustain pulses to non-overlap sustain pulses from 0 to M % as the weight value in other subfield increases from the lowest weight value. M may be a maximum ratio, and may be used for the subfield having a highest weight value from among a plurality of the subfields, or may be used for subfields having a weight value above some predetermined value. Similarly, the ratio may be maintained at 0 until a minimum weight value is reached. M may be an integer less than 100, e.g., 50.

For example, the ratio determining unit 250 may set the ratio of the overlap sustain pulses to the non-overlap sustain pulses in one subfield as 2:2, and the ratio of the overlap sustain pulses to the non-overlap sustain pulses in the other subfield having a higher weight value than the one subfield as 4:2.

As described, according to an exemplary embodiment of the present invention, since the ratio of overlap sustain pulses decreases as the weight value of subfields decreases, life-span and luminance maintenance rate are prevented from being deteriorated in the plasma display panel (PDP).

The arranging unit 260 may determine an arrangement of sustain pulses for each subfield according to the ratio determined by the ratio determining unit 250 in operation S450. For example, when the number of sustain pulses applied to one subfield is twenty, the ratio of the overlap sustain pulses and the non-overlap sustain pulses may be 4:2. Thus, the arranging unit 260 may arrange four overlap sustain pulses, followed by two non-overlap sustain pulses, and subsequently followed by four overlap sustain pulses. In a like manner, the arranging unit 260 may arrange the twenty allocated sustain pulses.

Then, the arranging unit 260 applies driving control signals according to the arranged sustain pulses to the scan and sustain electrode drivers 400 and 500.

According to an exemplary embodiment of the present invention, the arranging unit 260 may first arrange the overlap sustain pulses, and subsequently arrange the non-overlap sustain pulses. Since the sustain discharge may be generated between the Y and X electrodes before the wall charges are eliminated by the self-erase discharge when the overlap sustain pulse(s) are applied, a strong sustain discharge is generated, and the wall charges may be sufficiently formed on the X and Y electrodes. In addition, after the wall charges are sufficiently formed on the X and Y electrodes, the self-erase discharge is not generated when the non-overlap sustain pulse(s) is subsequently applied to the X and Y electrodes.

Referring to FIG. 5A and FIG. 5B, the controller 200 may arrange the ratio of the allocated sustain pulses as a ratio of overlap sustain pulses and non-overlap sustain pulses as 2:2 in a first subfield among a plurality of subfield, and may arrange the allocated sustain pulses as a ratio of overlap sustain pulses and non-overlap sustain pulses as 4:2 in a second subfield among a plurality of subfields. FIG. 5A and FIG. 5B shows a weight value of the first subfield being lower than weight value of the second subfield. As described, the arranged sustain pulses may be applied to the X and Y electrodes during the sustain period of the first and second subfields.

In the sustain period of the first and second subfields, the sustain pulses applied to the X and Y electrodes may be divided into a plurality of groups G1 to G4, as illustrated in FIGS. 5A and 5B, according to the overlap sustain pulse and the non-overlap sustain pulse. In this case, the overlap sustain pulses are applied to a first group G1. Then, since the sustain discharge is sufficiently generated between the X and Y electrodes as described above before the wall charges are eliminated by the self-erase discharge, the wall charges may be sufficiently formed on the X and Y electrodes.

According to the exemplary embodiment of the present invention, the self-erase discharge may be prevented while a luminance maintenance rate is prevented from being deteriorated. Accordingly, the after-image effect and discharge spots may be prevented, and the sustain discharge may be appropriately generated.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method for driving a plasma display while dividing one frame into a plurality of subfields respectively having weight values in a plasma display including a plurality of discharge cells, the method comprising:
determining a total number of sustain pulses applied to the discharge cells during the frame from a plurality of video signals input during one frame;
allocating sustain pulses to a sustain period of each subfield based on the total number of sustain pulses;
determining a ratio of overlap sustain pulses and non-overlap sustain pulses according to a weight value of each subfield; and
arranging the sustain pulses allocated to each subfield as the overlap sustain pulses and the non-overlap sustain pulses according to the determined ratio.

2. The method as claimed in claim 1, wherein determining the ratio comprises increasing the ratio of the overlap sustain pulses to the non-overlap sustain pulses as the weight value of subfields increases.

3. The method as claimed in claim 2, wherein the arranging of the sustain pulses comprises:
arranging the overlap sustain pulses at the determined ratio followed by the non-overlap sustain pulses at the determined ratio; and
alternately arranging the overlap sustain pulses and the non-overlap sustain pulses at the determined ratio according to the number of sustain pulses allocated to each subfield.

4. The method as claimed in claim 1, wherein:
each sustain pulse has a high level voltage and a low level voltage;
each overlap sustain pulse has a period in which a period for changing a voltage of a first sustain pulse applied to the plurality of discharge cells from the high level voltage to the low level voltage overlaps a period in which a voltage of a second sustain pulse applied to the plurality of discharge cells immediately after the first sustain pulse has the high level voltage; and
each non-overlap sustain pulse does not have a period in which a third sustain pulse applied to the plurality of discharge cells overlaps a fourth sustain pulse applied to the plurality of discharge cells immediately after the third sustain pulse.

5. A plasma display, comprising:
a plurality of discharge cells,
a controller configured to divide one frame into a plurality of subfields, to allocate sustain pulses to respective subfields, to determine a ratio of overlap sustain pulses and non-overlap sustain pulses in the respective subfields according to a weight value of the respective subfields, and to arrange the sustain pulses allocated to the respective subfields as the overlap sustain pulses and the non-overlap sustain pulses based on the determined ratio; and
a driver configured to sequentially apply the arranged sustain pulses to the plurality of discharge cells in the respective subfields.

6. The plasma display as claimed in claim 5, wherein the controller is configured to increase the ratio of the overlap sustain pulses to the non-overlap sustain pulses as the weight value of subfields increases.

7. The plasma display as claimed in claim 6, wherein the controller is configured to arrange the overlap sustain pulses corresponding to the determined ratio followed by the non-overlap sustain pulses corresponding to the determined ratio in the respective subfields.

8. The plasma display as claimed in claim 5, wherein:
each sustain pulse has a high level voltage and a low level voltage;
each overlap sustain pulse has a period in which a period for changing a voltage of a first sustain pulse applied to the plurality of discharge cells from the high level voltage to the low level voltage overlaps a period in which a voltage of a second sustain pulse applied to the plurality of discharge cells immediately after the first sustain pulse has the high level voltage; and
each non-overlap sustain pulses does not have a period in which a third sustain pulse applied to the plurality of discharge cells overlaps a fourth sustain pulse applied to the plurality of discharge cells immediately after the third sustain pulse.

9. A method for driving a plasma display while dividing one frame into a plurality of subfields in a plasma display including a first electrode and a second electrode performing a display operation together, the method comprising:
applying a plurality of first sustain pulses to the first electrode in a sustain period of respective subfields; and
applying a plurality of second sustain pulses to the second electrode, the second sustain pulses having an opposite phase to that of the first sustain pulse in at least part of the sustain period,
wherein the plurality of first and second sustain pulses are grouped into a plurality of groups according to a pulse type, the first and second sustain pulses of a first group, which includes the first sustain pulse that is firstly applied to the first electrode in the sustain period, partially overlap, and the first and second sustain pulses of a second group among the plurality of groups do not overlap, and
the number of first and second sustain pulses included in the first group varies according to a weight value of the respective subfields.

10. The method as claimed in claim 9, wherein the number of first and second sustain pulses increases as the weight value increases.

11. The method as claimed in claim 9, wherein the first and second sustain pulses alternately have a high level and a low level voltage,
a period for changing a voltage of the first sustain pulse from the high level voltage to the low level voltage overlaps a period in which the second sustain pulse applied immediately after the first sustain pulse has the high level voltage when the first and second sustain pulses of the first group overlap, and
there is no period in which the first and second sustain pulses overlap when the first and second sustain pulses of the second group do not overlap.

12. The method as claimed in claim 11, wherein a pulse type of a third group among the plurality of groups is the same as that of the first group, a pulse type of a fourth group among the plurality of groups is the same as that of the second group, and the number of first and second sustain pulses included in the third group increases as the weight value increases.

13. A controller for use with a plasma display device, the controller comprising:
a dividing unit configured to divide one frame into a plurality of subfields and to allocate sustain pulses to respective subfields;
a ratio unit configured to determine a ratio of overlap sustain pulses and non-overlap sustain pulses in the respective subfields according to a weight value of the respective subfields; and
an arranging unit configured to arrange the sustain pulses allocated to the respective subfields as the overlap sustain pulses and the non-overlap sustain pulses based on the determined ratio.

14. The controller as claimed in claim 13, wherein the ratio unit is configured to increase the ratio of the overlap sustain pulses to the non-overlap sustain pulses as the weight value of subfields increases.

15. The controller as claimed in claim 14, wherein the arranging unit is configured to arrange the overlap sustain pulses corresponding to the determined ratio followed by the non-overlap sustain pulses corresponding to the determined ratio in the respective subfields.

16. The controller as claimed in claim 13, wherein:
each sustain pulse has a high level voltage and a low level voltage;
each overlap sustain pulse has a period in which a period for changing a voltage of a first sustain pulse applied to the plurality of discharge cells from the high level voltage to the low level voltage overlaps a period in which a voltage of a second sustain pulse applied to the plurality of discharge cells immediately after the first sustain pulse has the high level voltage; and
each non-overlap sustain pulses does not have a period in which a third sustain pulse applied to the plurality of discharge cells overlaps a fourth sustain pulse applied to the plurality of discharge cells immediately after the third sustain pulse.
